(19) United States
(12) Patent Application Publication
(10) Pub. No.: US 2025/0055621 A1
(43) Pub. Date: Feb. 13, 2025

(54) MONITORING OF SESSIONLESS POSITIONING VIA SIDELINK CONTROL INFORMATION FOR WIRELESS NETWORKS

(71) Applicant: Nokia Technologies Oy, Espoo (FI)

(72) Inventors: Diomidis MICHALOPOULOS, Munich (DE); Taylan SAHIN, Munich (DE); Prajwal KESHAVAMURTHY, Munich (DE); Anastasios KAKKAVAS, Munich (DE); Stepan KUCERA, Munich (DE)

(21) Appl. No.: 18/775,151

(22) Filed: Jul. 17, 2024

Related U.S. Application Data
(60) Provisional application No. 63/518,872, filed on Aug. 10, 2023.

(51) Int. Cl. H04L 5/00; H04W 72/25; H04W 92/18

(52) U.S. Cl. CPC H04L 5/0048; H04W 72/25; H04W 92/18

(57) ABSTRACT

A method includes receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmitting, by the first user device, sidelink control information including at least one of an indication that the first user device is performing sessionless positioning, a user device identifier of the first user device, the user device identifier of the second user device, or the SL-PRS identification information; and performing, by the first user device, at least one measurement on the sidelink-positioning reference signal transmitted by the second user device for sessionless positioning of the first user device.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to carlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency. 6G and other wireless networks are also being developed.

### SUMMARY

According to an example embodiment, a method may include: receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmitting, by the first user device, sidelink control information including at least one of an indication that the first user device is performing sessionless positioning, a user device identifier of the first user device, the user device identifier of the second user device, or the SL-PRS identification information; and performing, by the first user device, at least one measurement on the sidelink-positioning reference signal transmitted by the second user device for sessionless positioning of the first user device.

According to an example embodiment, a method may include receiving, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determining, by the second user device, based on the user device identifier of the second user device, that the sidelink control information is addressed to the second user device; and continuing to transmit or making an adjustment of a transmission of, by the second user device, the sidelink-positioning reference signal associated with the SL-PRS identification information.

According to an example embodiment, a method may include receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmitting, by the first user device, information including at least one of an indication that the first user device is performing sessionless positioning, a user device identifier of the first user device, the user device identifier of the second user device, or the SL-PRS identification information; and performing, by the first user device, at least one measurement on the sidelink-positioning reference signal transmitted by the second user device for sessionless positioning of the first user device.

According to an example embodiment, a method may include receiving, by a second user device from a first user device, information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determining, by the second user device, based on the user device identifier of the second user device, that the information is addressed to the second user device; and continuing to transmit or make an adjustment of a transmission of, by the second user device, the sidelink-positioning reference signal associated with the SL-PRS identification information.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user device (or UE) according to an example embodiment.

FIG. 3 is a flow chart illustrating operation of a user device (or UE) according to another example embodiment.

FIG. 4 is a diagram illustrating operation of a network according to an example embodiment.

FIG. 5 is a block diagram of a wireless station or node (e.g., network node, user node or UE, relay node, or other node).

### DETAILED DESCRIPTION

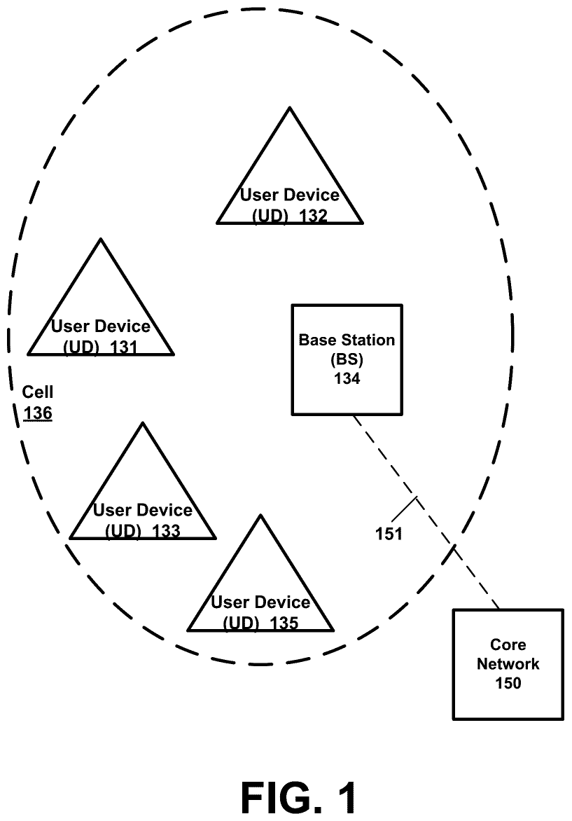

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (c) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, cach RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, cNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, cNB, BS, AP, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (cMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without the intervention of humans. Enhanced mobile broadband (cMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a cMBB UE (or an eMBB application running on a UE).

The techniques described herein may be applied to a wide variety of wireless technologies or wireless networks, such as LTE, LTE-A, 5G (New Radio (NR)), cmWave, and/or mm Wave band networks, IoT, MTC, eMTC, eMBB, URLLC, etc., or any other wireless network or wireless technology. These example networks, technologies or data service types are provided only as illustrative examples.

In some cases, a UE positioning function may be used to determine a geographic position (or location) of a UE. In some cases, UE positioning may be performed or determined based on positioning reference signals (PRSs). For example, a positioning reference signal (PRS) may be a reference signal that may be transmitted and/or received that may be used to obtain positioning measurements and/or to allow a UE position to be determined or estimated. In some cases, a UE position (or UE position estimate) may be determined, for example, based on positioning measurements, such as a measured timing and/or measured received power (or other signal measurement) of one or more PRSs, for example. For example, PRSs may be or may include PRS sequences that may be pseudo-random sequences that have good (or relatively high) auto-correlation properties and small (or relatively low) cross-correlation properties, e.g., to allow timing or time differences of two signals to be determined.

In the case of uplink/downlink (UL/DL) positioning (where PRS signals are communicated between a UE and a network node or gNB), PRS signals may include downlink (DL) PRS signals (transmitted by a gNB or other network node to a UE), or uplink (UL) PRS signals (transmitted by a UE to a gNB or network node).

Sidelink (SL) communications (which may also be referred to as device-to-device communications, or UE-to-UE communications) are communications directly between UEs (or directly between user devices or user nodes), e.g., without necessarily using or going through a network node (gNB or BS). A UE may obtain SL resources for a SL channel, to perform SL communications with one or more other nearby UEs. A UE may be involved in both traditional UE-gNB communications, and SL communications. Thus, a UE may have, for example, a UE-gNB radio link established for communication with a gNB or network node, and the UE may be part of a SL group in which the UE may transmit and/or receive signals or information via SL resources of a SL channel with other member UEs of the SL group, for example.

In a case of sidelink (SL) positioning, PRS signals may include sidelink positioning reference signals (SL-PRSs), which may include reference signals transmitted by a UE and/or received by a UE via a sidelink channel (e.g., sidelink resources that may be used for direct UE-to-UE communication) that may be used to obtain positioning measurements and/or position a UE or other object. In SL positioning, one or more UEs transmit SL-PRSs to one or more other UEs, to allow a positioning measurement(s) to be determined by the receiving UEs and/or to allow a position estimate of a UE to be calculated (based on one or more positioning measurements). In SL positioning, one or more UEs (that are participating in the positioning session) may determine a positioning measurement(s) (based on received SL-PRSs), such as amplitude or reference signal received power (RSRP), angle of arrival, time of arrival, phase, or other positioning measurement. Depending on the technique used for SL positioning, one or more of these positioning measurements are required to calculate a position estimate of a target UE (the UE to be positioned). Sidelink (SL) positioning may be performed using different or various positioning methods, such as, e.g., Time Difference of Arrival (TDOA), Angle of Departure (AoD), multi-round trip time (multi-RTT) positioning, Angle of Arrival (AOA), or other positioning techniques.

UEs that transmit data or signals via sidelink communications may typically transmit sidelink control information, which may include a user device identifier (UE ID) of the transmitting UE as a source UE ID, and may possibly indicate a UE ID of another UE that is a destination of the SCI, and possibly other information.

A UE may perform session-based positioning, in which a target-UE (T-UE) to be positioned establishes a sidelink positioning protocol (SLPP) session with an anchor UE (A-UE), where the A-UE will transmit SL-PRSs and the T-UE will perform positioning measurements based on the transmitted SL-PRSs from the A-UE. The session based positioning involves messages being directly exchanged between the A-UE and T-UE to agree on various parameters of the SLPP session and allow communication between the T-UE and A-UE. However, session based positioning has a disadvantage of requiring significant overhead in terms of time-frequency resources and battery power of the UEs to setup the SLPP session.

A UE may also perform sessionless positioning in which a T-UE performs positioning measurements on whatever SL-PRSs it can detect without establishing a SLPP session with other UEs. This is because various A-UEs may already be transmitting SL-PRSs, and thus, other UEs may be able to detect and perform positioning measurements on these SL-PRSs, without the necessity of establishing a SLPP session. Sessionless positioning may allow a UE (e.g., T-UE) to perform positioning measurements without incurring the significant overhead required to establish a SLPP session.

However, sessionless positioning has disadvantages. Because there is no session between the A-UE (e.g., a UE transmitting SL-PRSs) and the T-UE (the UE performing positioning measurements based on detected SL-PRSs), there is no mechanism for the T-UE to communicate with the A-UE. Thus, the A-UE has no way to know if other UEs are performing positioning based on any of its transmitted SL-PRSs. Thus, as a result, an A-UE may make decisions on whether to add a new SL-PRS or discontinue transmitting existing SL-PRSs without feedback from other UEs, which may an inefficient approach, e.g., resulting in lower positioning performance and/or cause delays in performing positioning. In general, both anchor-UEs (A-UEs) and target-UEs (T-UEs) may transmit SL-PRSs, while the T-UE is typically performing positioning measurement to determine its position.

According to an example embodiment, an improved communications technique is provided in which a T-UE may include information in its sidelink control information (SCI) to notify an A-UE that the T-UE is performing sessionless positioning. Thus, the T-UE may notify the A-UE, via the T-UE's SCI, that the T-UE is performing sessionless positioning (e.g., which may mean or may indicate that a SL-PRS transmitted by the A-UE is being used by the T-UE for sessionless positioning). Also, the T-UE's SCI may also include additional information (e.g., SL-PRS identification information) that may identify one or more specific SL-PRSs that are being used by the T-UE for sessionless positioning. This information may advantageously be transmitted by the T-UE within its SCI, without the T-UE establishing a SLPP session with a A-UE.

As noted, various UEs that transmit data or signals (such as SL-PRSs) via sidelink communications may typically transmit sidelink control information (SCI), which may be monitored by other SL UEs (e.g., including T-UEs and/or A-UEs, and/or other SL UEs). Thus, according to an example embodiment, a T-UE may transmit SCI, which may include one or more fields or parameters, which may notify an A-UE that the T-UE is performing sessionless positioning and/or may identify specific SL-PRSs transmitted by an A-UE that the T-UE is using for positioning measurements. For example, the T-UE may transmit sidelink control information (SCI) including at least one of an indication that the T-UE is performing sessionless positioning, a user device identifier (UE ID) of the T-UE (e.g., as a source of the SCI), a user device identifier (e.g., UE ID) of the A-UE (e.g., as a destination of the SCI), and/or sidelink-positioning reference signal (SL-PRS) identification information associated with sidelink-positioning reference signals (SL-PRSs) transmitted by the A-UE.

For example, in some example embodiments an A-UE may decode the SCI only if the destination UE ID in the SCI is the UE ID of the A-UE (e.g., a destination of the SCI set to the UE ID of the A-UE, which indicates that the SCI is addressed to the A-UE). According to an example embodiment, the A-UE, receiving SCI addressed to the A-UE, including an indication that the T-UE is performing sessionless positioning, thus receives a notification from the T-UE that the T-UE is performing sessionless positioning based on one or more SL-PRSs transmitted by the A-UE.

In some example embodiments, an A-UE (anchor-UE, transmitting one or more SL-PRSs) may transmit multiple SL-PRSs. According to an example embodiment, the T-UE may indicate which specific SL-PRSs the T-UE is using (or requesting for use) for sessionless positioning by including SL-PRS identification information associated with the SL-PRSs transmitted by the A-UE that are used by the T-UE for sessionless positioning. In this manner, the A-UE may make a more informed decision about modifying or adjusting its SL-PRS transmission configuration, e.g., determining which SL-PRSs to continue transmitting (e.g., if more than a threshold number (e.g., one or more T-UEs) are using such SL-PRS for sessionless position), and/or which of its SL-PRSs to discontinue transmitting (e.g., if less than a threshold number of T-UEs are using such SL-PRS for sessionless positioning), but without requiring the T-UE to establish a SLPP session with the A-UE.

According to an example embodiment, the SL-PRS identification information associated with the sidelink-positioning reference signals transmitted by the A-UE may include at least one of the following: a sidelink-positioning reference signal (SL-PRS) sequence identifier (SL-PRS sequence ID) associated with the sidelink-positioning reference signals transmitted by the A-UE; or a sidelink-positioning reference signal (SL-PRS) resource identifier (SL-PRS resource ID) indicating or associated with resources for the sidelink-positioning reference signals transmitted by the A-UE.

For example, SL-PRS sequence IDs may be assigned (e.g., by a server UE or by a LMF or other network node) to a UE. Thus, for example, there may be a unique SL-PRS for cach SL-PRS sequence ID (or there may be a specific SL-PRS associated with each SL-PRS sequence ID). For example, an equation, known to the UE and the LMF or server UE, may be used to determine the SL-PRS based on the equation and the SL-PRS sequence ID. In addition, a pool or set of time-frequency resources may be allocated or assigned for transmission of a set of SL-PRSs. For example, different SL-PRS resources may be associated with (or used to transmit SL-PRSs for) different SL-PRS resource IDs.

Thus, in an example embodiment, the T-UE may identify a specific SL-PRS to the A-UE that the T-UE is using for sessionless positioning by the T-UE including at least one of the SL-PRS sequence ID or the SL-PRS resource ID within the T-UE's SCI. The A-UE may receive this type of information (within respective SCI) from one or more (e.g., or even multiple) T-UEs. The A-UE may modify or adjust its SL-PRS transmission configuration, e.g., by making a determination which SL-PRSs to continue transmitting, which SL-PRSs to drop or discontinue transmitting, which SL-PRSs to adjust resources (e.g., to transmit more or less frequent), to initiate transmission of a new SL-PRS, based on this SCI transmitted by one or more T-UEs, and/or some other reason such as indication by server UE or LMF.

In this manner, the A-UE may obtain feedback from one or more T-UEs that may be performing sessionless positioning based on SL-PRSs transmitted by the A-UE, without a SLPP session being established between the T-UE and the A-UE.

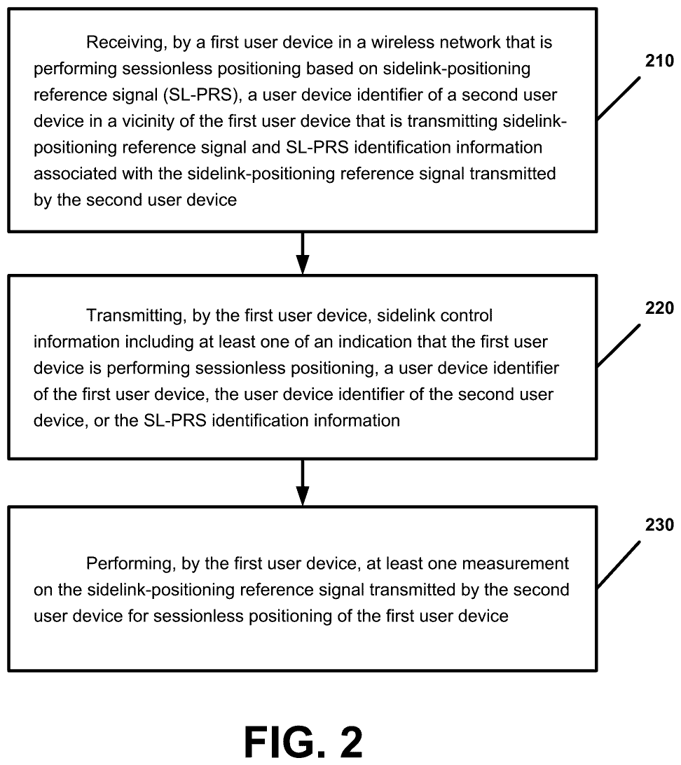

FIG. 2 is a flow chart illustrating operation of a target-UE (T-UE) according to an example embodiment. Operation 210 includes receiving, by a first user device (e.g., T-UE) in a wireless network that is performing sessionless positioning based on sidelink-positioning reference signal (SL-PRS), a user device identifier of a second user device (e.g., UE ID of an anchor-UE (A-UE)) in a vicinity of the first user device that is transmitting sidelink-positioning reference signal and SL-PRS identification information associated with the sidelink-positioning reference signal transmitted by the second user device. Operation 220 includes transmitting, by the first user device (by the T-UE), sidelink control information (SCI) including at least one of an indication that the first user device is performing sessionless positioning (e.g., a field, bit or flag in the SCI indicating that the T-UE transmitting the SCI is performing sessionless positioning), a user device identifier of the first user device, the user device identifier of the second user device, or the SL-PRS identification information. And, operation 230 includes performing, by the first user device, at least one measurement on the sidelink-positioning reference signal transmitted by the second user device for sessionless positioning of the first user device (e.g., T-UE may perform a measurement on the SL-PRS for positioning the T-UE, such as measuring an amplitude or reference signal received power (RSRP), an angle of arrival, a time of arrival, a phase, or other measurement on the SL-PRS from the A-UE).

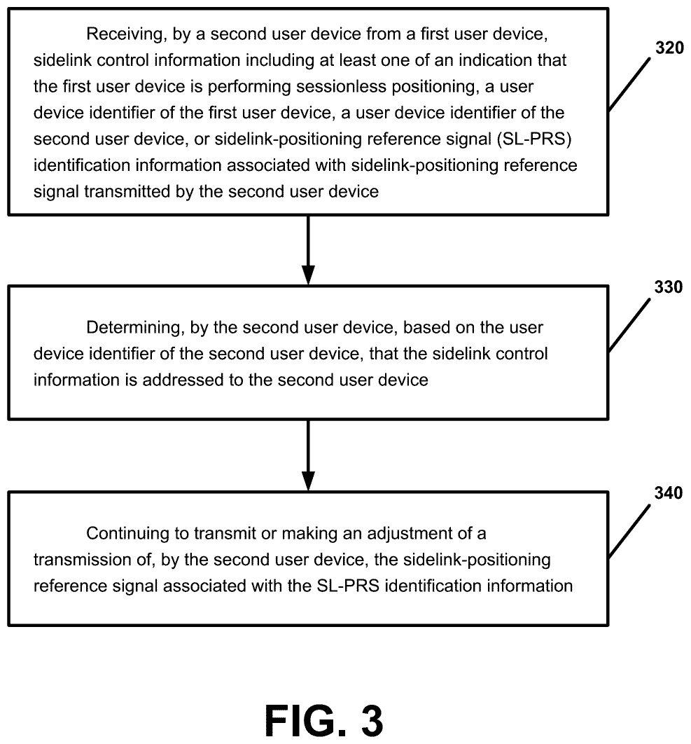

With respect to the methods of FIGS. 2 and 3, and examples described herein, instead of transmitting sidelink control information (SCI), the first UE (e.g., T-UE) may transmit (and the second UE or A-UE may receive) any information or message. SCI is an example of information that may be transmitted by the T-UE.

With respect to the method of FIG. 2, the transmitting sidelink control information may include: transmitting, by the first user device, the sidelink control information including the indication that the first user device is performing sessionless positioning, the user device identifier of the first user device as a source of the sidelink control information, the user device identifier of the second user device as a destination of the sidelink control information, and the SL-PRS identification information.

With respect to the method of FIG. 2, the performing may include: detecting, by the first user device, sidelink-positioning reference signal from the second user device; and performing, by the first user device, at least one measurement on the detected sidelink-positioning reference signal for sessionless positioning of the first user device.

With respect to the method of FIG. 2, the method may further include transmitting, by the first user device to a server user device or a location management function, at least one of a request to perform sessionless positioning, or a user device identifier of one or more second user devices that the first user device has detected or received signal from.

With respect to the method of FIG. 2, the SL-PRS identification information associated with the sidelink-positioning reference signal transmitted by the second user device may incude at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

With respect to the method of FIG. 2, the method may further include receiving, by the first user device, information indicating a period or periodicity that the first user device should transmit, the sidelink control information.

With respect to the method of FIG. 2, the method may further include receiving, by the first user device from a server user device or a location management function, a message indicating how to indicate sessionless positioning or information that the first user device should include within its sidelink control information.

FIG. 3 is a flow chart illustrating operation of an anchor-UE (A-UE) according to an example embodiment. Operation 310 includes receiving, by a second user device (e.g., anchor-UE (A-UE)) from a first user device (e.g., target-UE (T-UE)), sidelink control information (SCI) including at least one of an indication that the first user device is performing sessionless positioning, a user device identifier of the first user device (e.g., UE ID of T-UE), a user device identifier of the second user device (e.g., UE ID of A-UE), or sidelink-positioning reference signal (SL-PRS) identification information associated with sidelink-positioning reference signal transmitted by the second user device. Operation 320 includes determining, by the second user device, based on the user device identifier of the second user device, that the sidelink control information is addressed to the second user device. And, operation 330 includes continuing to transmit or making an adjustment of a transmission of, by the second user device, the sidelink-positioning reference signal associated with the SL-PRS identification information.

With respect to the method of FIG. 3, the method may further include receiving, by the second user device, a signal power or signal quality threshold, above which a received sidelink control information is considered to be valid; and determining that the received sidelink control information is valid based on a signal power or a signal quality of the received sidelink control information.

With respect to the method of FIG. 3, the continuing to transmit or making an adjustment may include: continuing to transmit or making the adjustment of a transmission of, by the second user device, the sidelink-positioning reference signal associated with the SL-PRS identification information based on the received sidelink control information.

With respect to the method of FIG. 3, the continuing to transmit or making an adjustment may include: continuing to transmit or making the adjustment of a transmission of, by the second user device, the sidelink-positioning reference signal associated with the SL-PRS identification information based on the determination that the received sidelink control information is valid and addressed to the second user device.

With respect to the method of FIG. 3, the receiving sidelink control information may include: receiving, by the second user device from the first user device, sidelink control information including the indication that the first user device is performing sessionless positioning, the user device identifier of the first user as a source of the sidelink control information, the user device identifier of the second user device as a destination of the sidelink control information, and the sidelink-positioning reference signal (SL-PRS) identification information.

With respect to the method of FIG. 3, the SL-PRS identification information associated with the sidelink-positioning reference signal transmitted by the second user device may include at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

With respect to the method of FIG. 3, the method may further include receiving, by the second user device, at least one of the following: one or more user device identifiers of user devices for which the second user device should monitor the sidelink control information; an indication of a time window, within which the second user device should monitor the sidelink control information from the one or more user devices; or an indication that the second user device should maintain a sidelink-positioning reference signal transmission associated with a sidelink-positioning reference signal identification information indicated in the sidelink control information, only if there is a threshold number of user devices that indicate within their sidelink control information that sessionless positioning is performed based on the sidelink-positioning reference signal.

With respect to the method of FIG. 3, the making the adjustment may include: making a determination, by the second user device to modify transmission of one or more sidelink-positioning reference signals; transmitting, by the second user device to a server user device or a location management function, a request to modify the sidelink-positioning reference signal transmission; receiving, by the second user device from server user device or a location management function based on the request, a message indicating an updated sidelink-positioning reference signal transmission configuration for the second user device; and modifying, by the second user device based on the received updated sidelink-positioning reference signal transmission configuration, the sidelink-positioning reference signal transmission.

With respect to the method of FIG. 3, the modifying the sidelink-positioning reference signal transmission may include the second user device performing at least one of the following: discontinuing a transmission of a sidelink-positioning reference signal transmission based on less than a threshold number of user devices performing sessionless positioning based on the sidelink-positioning reference signal; beginning transmission of a new sidelink-positioning reference signal; or adjusting or changing time-frequency resources to be used for the sidelink-positioning reference signal transmission.

With respect to the method of FIG. 3, the beginning transmission of a new sidelink-positioning reference signal or the adjusting or changing of time-frequency resources to be used for the sidelink-positioning reference signal transmission is based on preconfigured parameters that are preconfigured to the second user device by a server user device or location management function.

While a SLPP session has not been established between the T-UE and A-UE, SLPP messages may be sent from a location management function (LMF) or server UE to the A-UE and to the T-UE. Techniques are provided that allow the anchor UE (A-UE) to infer or determine whether its SL-PRS transmissions have been detected and measured by at least one target UE (T-UE) performing sessionless SL positioning. The techniques also describe or may also provide how the A-UEs may be configured to monitor SCI transmissions from T-UEs performing sessionless positioning. Similarly, the T-UE indicate in their SCI the existence of positioning operation in sessionless mode, along with relevant positioning parameters in sessionless mode such as SL-PRS identification information (e.g., which may include SL-PRS sequence IDs and/or SL-PRS resource IDs). Based on such SCI monitoring, the A-UE is able to become aware of the existence of one or more T-UEs in the area that are measuring its own SL-PRS, although it does not have any direct communication with those T-UEs, as sessionless SL positioning implies (e.g., no session has been established between the T-UE and A-UE, but the A-UE may receive SCI (sidelink control information) from the T-UE so that the A-UE may learn or determine that the T-UE is performing sessionless positioning based on the A-UE's SL-PRS transmission(s)). The A-UE may adjust transmission of its SL-PRS configuration, for example, based on the SCI transmitted by one or more T-UEs.

Also, for example, a configuration may be sent to the T-UE to configure what information should be included in the sidelink control information (SCI) transmitted by the T-UE. Also, another configuration may be sent to the A-UE to configure the A-UE to monitor SCI of various T-UEs for information related to T-UE sessionless positioning. The configuration(s) (e.g., sent to T-UE and/or to A-UE) may be sent by the entity that manages SL positioning, e.g., which is either the LMF (location management function) or the server UE.

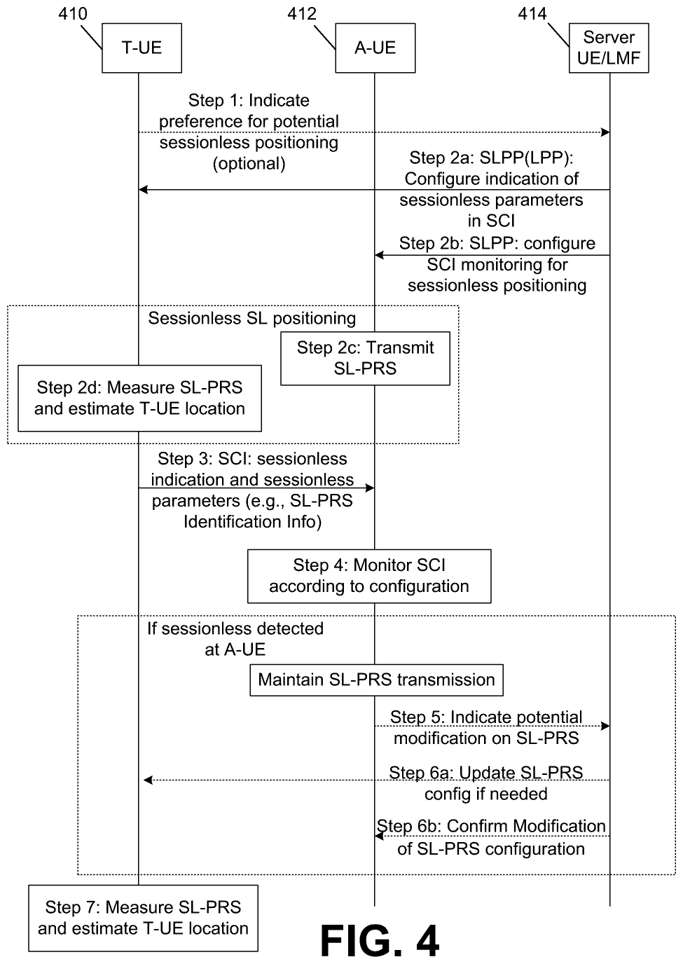

FIG. 4 is a diagram illustrating operation of a network according to an example embodiment. A target-UE (T-UE) may perform measurements based on SL-PRSs from one or more anchor-UEs (A-UEs), so that the T-UE may determine its position or location, for example. A server UE or LMF (server UE/LMF 414) may also be provided. Various example steps or operations are described with reference to FIG. 4.

In step 1 of FIG. 4, the T-UE 410 may indicate to the server UE/LMF 414 its preference or a request to perform sessionless positioning (and thus, the T-UE indicating its readiness to perform sessionless positioning). This may be regarded as an extended positioning request by the T-UE (e.g., extended MO-LR), where the sessionless preference and readiness is indicated. In a further embodiment, the T-UE 410 may indicate to the server UE/LMF 414 the UE IDs (UE identifiers) of A-UEs it has discovered in its vicinity, with which it intends to engage in sessionless positioning (e.g., the A-UEs in vicinity of the T-UE that the T-UE would like to use their SL-PRSs for measurements for UE positioning of the T-UE). Such indication may allow the server UE/LMF 414 to determine which A-UEs to configure in Step 2a/2b.

In step 2a of FIG. 4, the server UE/LMF 414 configures the T-UE 410 on how to indicate sessionless positioning in its SCI, and/or what information to include in the SCI sessionless positioning field. For example, if this configuration comes from server UE this configuration may be or may correspond to a new SLPP (sidelink positioning protocol) message; if this configuration comes from the LMF this configuration may be or may correspond to a new IE (information element) as part of the assistance data towards T-UE 410. The content of this new SLPP/LPP message may include one or more of the following, for example: 1) UE IDs of A-UEs in the vicinity of T-UE 410 that are currently transmitting SL-PRS. T-UEs will then include the IDs of those A-UEs in the SCI Destination ID field, to indicate it is performing sessionless positioning by measuring SL-PRS transmitted by them (by those indicated A-UEs); SL-PRS identification information, such as, e.g., SL-PRS sequence IDs and/or SL-PRS resource IDs of the SL-PRS transmitted by the A-UEs indicated in field above; 3) Periodicity of the indication: to save resources, the T-UE 410 may be configured to not indicate sessionless positioning in every transmitted SCI, but include such indication with a configured periodicity, which can be described in number of slots, subframes, frames or ms, etc.

In step 2b of FIG. 4, the server UE/LMF 414 configures A-UE 412 with respect to monitoring SCI for sessionless positioning. This may be a new SLPP (or LPP) message, SLPPSessionlessSCIMonitoring. The content of the SLPPSessionlessSCIMonitoring configuration message may include, for example: 1) reference signal received power (RSRP) or reference signal received quality (RSRQ) threshold or range within such range (or above such threshold) an SCI monitoring is considered valid (for instance, for low RSRP/RSRQ the SCI monitoring should be discarded as non-reliable (not valid), while a received SCI having a RSRP or RSRQ above such RSRP/RSRQ threshold is deemed to be valid or reliable); 2) Source ID(s) of the T-UEs whose SCI needs to be monitored at A-UE 412. This may be the ID of the T-UE 410 obtained at Step 1, for example. In this field the server UE/LMF 414 indicates to A-UE 412 the ID of the sessionless T-UE 410, for the A-UE 412 to know what SCI source ID to be monitored for this purpose, for example.

In a further embodiment, in addition to Source ID(s) criterion (e.g., in which an A-UE 412 monitors SCI from T-UEs having specific source IDs for which the A-UE 412 has been configured by the server UE/LMF 414 to monitor), the server UE/LMF 414 may configure A-UE 412 to maintain transmission of SL-PRS only when the A-UE 412 receives an SCI indicating the existence of positioning operation in sessionless mode and/or including SL-PRS identification information of the SL-PRS based on which the sessionless positioning is performed. In a further embodiment, the server UE/LMF 414 may configure A-UE 412 to start transmission of a new SL-PRS when the A-UE 412 receives an SCI which includes a SL-PRS trigger indication. The SL-PRS trigger indication may be an indication in the SCI of the T-UE requesting from the entity designated at the destination ID of the SCI to transmit SL-PRS. If the ID of the A-UE is the destination ID in the SCI message then the A-UE is caused to transmit SL-PRS.

For example, the T-UE 410 sending an SCI may trigger or cause a SL PRS transmission at the A-UE 412 that receives the SCI, e.g., T-UE 410 sends the SCI to trigger SL PRS transmission at A-UE 412. The configuration of the SL PRS transmission by the A-UE 412, which may include transmission parameters of this SL-PRS (e.g., SL PRS bandwidth, number of symbols, comb size, SL PRS sequence information, etc.) can be (pre-)configured by network (such as LMF) or another UE (which could be a same or different T-UE, or server UE).

In addition, based on sidelink control information (SCI) (e.g., which may include UE ID of the A-UE and SL-PRS identification information) received by an A-UE 412 from T-UE 410, the A-UE 412 may, for example, continue to transmit or make an adjustment of a transmission of the SL-PRS associated with the SL-PRS identification information. In an example embodiment, based on the SCI, the A-UE 412 may modify a SL-PRS transmission, which may include performing one or more of the following: discontinuing a transmission of a sidelink-positioning reference signal transmission based on, e.g., less than a threshold number of UEs performing sessionless positioning based on the sidelink-positioning reference signal; beginning transmission of a new sidelink-positioning reference signal; or adjusting or changing time-frequency resources to be used for the sidelink-positioning reference signal transmission.

For example, beginning transmission of a new sidelink-positioning reference signal or the adjusting or changing of time-frequency resources to be used for the sidelink-positioning reference signal transmission may be based on an SL-PRS trigger indication and/or preconfigured parameters that are preconfigured to the A-UE by a server UE or location management function. In an example embodiment, the SL-PRS trigger indication may be the SL-PRS identification information.

In a further embodiment, the A-UE 412 may be further configured with a time window, starting from the reception of the configuration or the reception of the latest SCI including a sessionless indication, within which it should monitor SCIs to determine whether to maintain its SL-PRS transmission.

The T-UE 410 and A-UE 412 may be engaged in a sessionless positioning of the T-UE 410. For example, upon the server UE/LMF 414 providing one or both configurations to the T-UE 410 and/or A-UE 412, A-UE 412 and T-UE 410 may be engaged in a sessionless positioning mode, which involves A-UE 412 transmitting SL-PRS and T-UE 410 measuring SL-PRS (T-UE 410 performing measurements on the SL-PRS from the A-UE 412), though without any SLPP message exchange between the T-UE 410 and A-UE 412 (e.g., no SLPP session has been established between A-UE 412 and T-UE 410). Also, for example, a typical or common sessionless positioning scenario includes or involves T-UE 410 performing UE-based positioning, that is the T-UE 410 estimating its own position or location based on the measurements the T-UE 410 performs based on SL-PRS signals. In a variant, T-UE may provide the positioning measurements to another entity (for example, the LMF or server UE) for the other entity to estimate the location of the T-UE.

Thus, at step 2c of FIG. 4, A-UE 412 transmits SL-PRSs. At step 2d, the T-UE 410 performs measurements on the SL-PRS from the A-UE 412, and these measurements may be used by the T-UE for positioning of the T-UE 410 (e.g., the T-UE 410 may determine or estimate its own location or position based on these measurement(s)).

In step 3, the T-UE 410 performing sessionless positioning indicates the presence of sessionless positioning (e.g., thus, indicating that the T-UE 410 is performing sessionless positioning) in its SCI message. Also, according to an example embodiment, the T-UE 410 may include additional information in its SCI, such as information for A-UE 412 to understand or determine which SL-PRS of the A-UE 412 is being used or should be maintained by the A-UE 412, e.g., which SL-PRS sequence and/or SL-PRS resource ID should be maintained, following configuration from Step 2a. For example, the T-UE 410 may include, within its SCI, SL-PRS identification information (e.g., SL-PRS sequence ID and/or SL-PRS resource ID) that may indicate or identify one or more specific SL-PRS of the A-UE 412 that are being used or may be used by the T-UE 410 for measurements for T-UE positioning.

Following configuration, T-UE 410 may include in the SCI message an indication that is performing sessionless positioning. The T-UE 410 may also indicate the UE ID of T-UE 410 as a source of the SCI, and UE ID of the A-UE 412 as a destination of the SCI. Also, T-UE 410 may include in its SCI the SL-PRS identification information, e.g., such as SL-PRS sequence ID and/or SL-PRS resource IDs of SL-PRS measured in sessionless mode. For example, including in the SCI transmitted by the T-UE 410 the UE ID of A-UE 412 as a destination of the SCI and the indication that the T-UE is performing sessionless positioning may inform (or may indicate to) the A-UE 412 that the T-UE 410 is using a SL-PRS of the A-UE 412 for positioning (and thus, e.g., A-UE 412 may make a decision whether to continue to transmit such SL-PRS(s)). Similarly, by including the SL-PRS identification information in the SCI of T UE 410, the SCI may notify the A-UE 412 which specific SL-PRS of the A-UE 412 that the T UE 410 is using or is planning to use for UE positioning measurements (since the A-UE 412 may transmit multiple SL-PRSs, and the T-UE 410 may only be using one or some of them for positioning measurements, for example).

In step 4 of FIG. 4, A-UE monitors the SCI transmission by the T-UE 410 according to configuration obtained in Step 2b. If the A-UE 412 detects that at least one T-UE 410 is performing sessionless positioning by using at least one SL-PRS transmitted by the A-UE associated with a SL-PRS sequence ID or SL-PRS resource ID transmitted by the A-UE: 1) the A-UE 412 may decide to maintain the transmission of such SL-PRS associated with the indicated SL-PRS sequence ID(s) or resource ID(s) active to allow for T-UE 410 continue performing sessionless positioning based on such SL-PRS; and 2) the A-UE 412 may decide to trigger or initiate the transmission of SL-PRS (if it hasn't been transmitting before) to allow for T-UE performing sessionless positioning. On the other hand, if no T-UEs indicated they are using a specific SL-PRS of the A-UE 412 (e.g., SL-PRS sequence ID or SL-PRS resource ID of such SL-PRS are not indicated in SCI of any UE for such SL-PRS currently transmitted by the A-UE 412), then the A-UE 412 may make a determination or decision to discontinue transmitting such SL-PRS, or may adjust time-frequency resources of such SL-PRS to transmit this SL-PRS less frequently or with a smaller period or periodicity, e.g., to conserve resources in such a case.

In step 5 of FIG. 4, the A-UE412 may decide to modify its SL-PRS transmission configuration (e.g., modify SL-PRS resources for one of its SL-PRS, discontinue transmitting a SL-PRS, add a new SL-PRS to be transmitted, or other SL-PRS change or modification) possibly based on the indication that part of its SL-PRS transmission are used for sessionless positioning, and/or some other reason/indication. In that case, at step 5, the A-UE 412 indicates to server UE/LMF 414 the proposed modification to the SL-PRS transmission configuration of the A-UE 412.

Step 6: The server UE/LMF 414 processes this indication of requested or proposed change to SL-PRS transmission configuration of the A-UE 412, and assesses whether the proposed SL-PRS changes (e.g., changing resources of SL-PRS, discontinuing transmission of a SL-PRS, adding a transmission of a new SL-PRS or other change or modification to the SL-PRS transmissions of the A-UE 412) at the A-UE 412 are in accordance with or consistent with the positioning operation and/or needs of the T-UE 410 or other T-UEs in the vicinity of the A-UE 412. In case any update on the positioning configuration for the A-UE 412 is needed, server UE or LMF 414 updates SL-PRS configuration accordingly, via an updated SLPP/LPP (Step 6a, 6b). At step 6b, the server UE/LMF 414 may confirm that the proposed or requested change to the A-UE's SL-PRS transmission configuration is accepted, or the server UE/LMF 414 may provide an updated SL-PRS transmission configuration that the A-UE 412 should use (which might be different from what the A-UE 412 has proposed). At step 6b, the server UE/LMF 414 may also send a message to the T-UE 410 to inform the T-UE 410 of the changes or modifications to the SL-PRS configuration of the A-UE 412.

At step 7 of FIG. 4, the A-UE 412 transmits its SL-PRSs in accordance with the requested or updated SL-PRS transmission configuration, e.g., which may include the A-UE 412 continuing to transmit a SL-PRS that was indicated by a T-UE 410 as being used for sessionless positioning, changing or modifying time-frequency resources of one or more SL-PRSs transmitted by the A-UE 412, discontinuing transmission of a SL-PRS, adding a transmission (starting to transmit or initiating transmission) of a new SL-PRS, etc. For example, the A-UE 412 continuing to transmit a SL-PRS (or A-UE 412 making other changes to its SL-PRS transmission configuration) may be, based on or in response to SCI transmitted by T-UE 410 (and/or based on SCI transmitted by other UEs). Based on one or more of these SL-PRSs transmitted by the A-UE 412, the T-UE 410 may perform measurements for sessionless positioning of the T-UE 410.

Some further examples will be provided.

Example 1. A method comprising: receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmitting, by the first user device, sidelink control information including at least one of an indication that the first user device is performing sessionless positioning, a user device identifier of the first user device, the user device identifier of the second user device, or the SL-PRS identification information; and performing, by the first user device, at least one measurement on the sidelink-positioning reference signal transmitted by the second user device for sessionless positioning of the first user device.

Example 2. The method of Example 1, wherein the transmitting sidelink control information comprises: transmitting, by the first user device, the sidelink control information including the indication that the first user device is performing sessionless positioning, the user device identifier of the first user device as a source of the sidelink control information, the user device identifier of the second user device as a destination of the sidelink control information, and the SL-PRS identification information.

Example 3. The method of any of Examples 1-2, wherein the performing comprises: detecting, by the first user device, sidelink-positioning reference signal from the second user device; and performing, by the first user device, at least one measurement on the detected sidelink-positioning reference signal for sessionless positioning of the first user device.

Example 4. The method of any of Examples 1-3, further comprising: transmitting, by the first user device to a server user device or a location management function, at least one of a request to perform sessionless positioning, or a user device identifier of one or more second user devices that the first user device has detected or received signal from.

Example 5. The method of any of Examples 1-4 wherein the SL-PRS identification information associated with the sidelink-positioning reference signal transmitted by the second user device comprises at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

Example 6. The method of any of Examples 1-5, further comprising: receiving, by the first user device, information indicating a period or periodicity that the first user device should transmit, the sidelink control information.

Example 7. The method of any of Examples 1-7, further comprising: receiving, by the first user device from a server user device or a location management function, a message indicating how to indicate sessionless positioning or information that the first user device should include within its sidelink control information.

Example 8. An apparatus, comprising: at least one processor; and at least one memory storing instructions that, when executed by the at least one processor, cause the apparatus at least to: receive, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmit, by the first user device, sidelink control information including at least one of an indication that the first user device is performing sessionless positioning, a user device identifier of the first user device, the user device identifier of the second user device, or the SL-PRS identification information; and perform, by the first user device, at least one measurement on the sidelink-positioning reference signal transmitted by the second user device for sessionless positioning of the first user device.

Example 9. The apparatus of Example 8, wherein causing the apparatus to transmit the sidelink control information comprises causing the apparatus to: transmit, by the first user device, the sidelink control information including the indication that the first user device is performing sessionless positioning, the user device identifier of the first user device as a source of the sidelink control information, the user device identifier of the second user device as a destination of the sidelink control information, and the SL-PRS identification information.

Example 10. The apparatus of any of Examples 8-9, wherein causing the apparatus to perform comprises causing the apparatus to: detect, by the first user device, sidelink-positioning reference signal from the second user device; and perform, by the first user device, at least one measurement on the detected sidelink-positioning reference signal for sessionless positioning of the first user device.

Example 11. The apparatus of any of Examples 8-10, further causing the apparatus to: transmit, by the first user device to a server user device or a location management function, at least one of a request to perform sessionless positioning, or a user device identifier of one or more second user devices that the first user device has detected or received signal from.

Example 12. The apparatus of any of Examples 8-11, wherein the SL-PRS identification information associated with the sidelink-positioning reference signal transmitted by the second user device comprises at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

Example 13. The apparatus of any of Examples 8-12, further causing the apparatus to: receive, by the first user device, information indicating a period or periodicity that the first user device should transmit, the sidelink control information.

Example 14. The apparatus of any of Examples 8-13, further causing the apparatus to: receive, by the first user device from a server user device or a location management function, a message indicating information that the first user device should include within its sidelink control information.

Example 15. A non-transitory computer-readable storage medium comprising instructions stored thereon that, when executed by at least one processor, are configured to cause a computing system to: receive, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmit, by the first user device, sidelink control information including at least one of an indication that the first user device is performing sessionless positioning, a user device identifier of the first user device, the user device identifier of the second user device, or the SL-PRS identification information; and perform, by the first user device, at least one measurement on the sidelink-positioning reference signal transmitted by the second user device for sessionless positioning of the first user device.

Example 16. A method comprising: receiving, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determining, by the second user device, based on the user device identifier of the second user device, that the sidelink control information is addressed to the second user device; and continuing to transmit or making an adjustment of a transmission of, by the second user device, the sidelink-positioning reference signal associated with the SL-PRS identification information.

Example 17. The method of Example 16, further comprising: receiving, by the second user device, a signal power or signal quality threshold, above which a received sidelink control information is considered to be valid; and determining that the received sidelink control information is valid based on a signal power or a signal quality of the received sidelink control information.

Example 18. The method of Example 17, wherein the continuing to transmit or making an adjustment comprises: continuing to transmit or making the adjustment of a transmission of, by the second user device, the sidelink-positioning reference signal associated with the SL-PRS identification information based on the received sidelink control information.

Example 19. The method of Example 17, wherein the continuing to transmit or making an adjustment comprises: continuing to transmit or making the adjustment of a transmission of, by the second user device, the sidelink-positioning reference signal associated with the SL-PRS identification information based on the determination that the received sidelink control information is valid and addressed to the second user device.

Example 20. The method of any of Examples 16-19, wherein the receiving sidelink control information comprises: receiving, by the second user device from the first user device, sidelink control information including the indication that the first user device is performing sessionless positioning, the user device identifier of the first user as a source of the sidelink control information, the user device identifier of the second user device as a destination of the sidelink control information, and the sidelink-positioning reference signal (SL-PRS) identification information.

Example 21. The method of any of Examples 16-20, wherein the SL-PRS identification information associated with the sidelink-positioning reference signal transmitted by the second user device comprises at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

Example 22. The method of any of Examples 16-21, further comprising: receiving, by the second user device, at least one of the following: one or more user device identifiers of user devices for which the second user device should monitor the sidelink control information; an indication of a time window, within which the second user device should monitor the sidelink control information from the one or more user devices; or an indication that the second user device should maintain a sidelink-positioning reference signal transmission associated with a sidelink-positioning reference signal identification information indicated in the sidelink control information, only if there is a threshold number of user devices that indicate within their sidelink control information that sessionless positioning is performed based on the sidelink-positioning reference signal.

Example 23. The method of any of Examples 16-22, wherein the making the adjustment comprises: making a determination, by the second user device to modify transmission of one or more sidelink-positioning reference signals; transmitting, by the second user device to a server user device or a location management function, a request to modify the sidelink-positioning reference signal transmission; receiving, by the second user device from server user device or a location management function based on the request, a message indicating an updated sidelink-positioning reference signal transmission configuration for the second user device; and modifying, by the second user device based on the received updated sidelink-positioning reference signal transmission configuration, the sidelink-positioning reference signal transmission.

Example 24. The method of Example 23, wherein the modifying the sidelink-positioning reference signal transmission comprises the second user device performing at least one of the following: discontinuing a transmission of a sidelink-positioning reference signal transmission based on less than a threshold number of user devices performing sessionless positioning based on the sidelink-positioning reference signal; beginning transmission of a new sidelink-positioning reference signal; or adjusting or changing time-frequency resources to be used for the sidelink-positioning reference signal transmission.

Example 25. The method of Example 24, wherein the beginning transmission of a new sidelink-positioning reference signal or the adjusting or changing of time-frequency resources to be used for the sidelink-positioning reference signal transmission is based on preconfigured parameters that are preconfigured to the second user device by a server user device or location management function.

Example 26. An apparatus, comprising: at least one processor; and at least one memory storing instructions that, when executed by the at least one processor, cause the apparatus at least to: receive, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determine, by the second user device, based on the user device identifier of the second user device, that the sidelink control information is addressed to the second user device; and continue to transmit or make an adjustment of a transmission of, by the second user device, the sidelink-positioning reference signal associated with the SL-PRS identification information.

Example 27. The apparatus of Example 26, further causing the apparatus to: receive, by the second user device, a signal power or signal quality threshold, above which a received sidelink control information is considered to be valid; and determine that the received sidelink control information is valid based on a signal power or a signal quality of the received sidelink control information.

Example 28. The apparatus of Example 26, wherein causing the apparatus to continue to transmit or make an adjustment comprises causing the apparatus to: continue to transmit or make the adjustment of a transmission of, by the second user device, the sidelink-positioning reference signal associated with the SL-PRS identification information based on the received sidelink control information.

Example 29. The method of any of Examples 26-28, wherein causing the apparatus to continue to transmit or make an adjustment comprises: continue to transmit or make the adjustment of a transmission of, by the second user device, the sidelink-positioning reference signal associated with the SL-PRS identification information based on the determination that the received sidelink control information is valid and addressed to the second user device.

Example 30. The apparatus of any of Examples 26-29, wherein causing the apparatus to receive sidelink control information comprises causing the apparatus to: receive, by the second user device from the first user device, sidelink control information including the indication that the first user device is performing sessionless positioning, the user device identifier of the first user as a source of the sidelink control information, the user device identifier of the second user device as a destination of the sidelink control information, and the sidelink-positioning reference signal (SL-PRS) identification information.

Example 31. The apparatus of any of Examples 26-30, wherein the SL-PRS identification information associated with the sidelink-positioning reference signal transmitted by the second user device comprises at least one of the following: a sidelink-positioning reference signal sequence identifier associated with the sidelink-positioning reference signal transmitted by the second user device; or a sidelink-positioning reference signal resource identifier indicating or associated with resources for the sidelink-positioning reference signal transmitted by the second user device.

Example 32. The apparatus of any of Examples 26-31, further causing the apparatus to: receive, by the second user device, at least one of the following: one or more user device identifiers of user devices for which the second user device should monitor the sidelink control information; an indication of a time window, within which the second user device should monitor the sidelink control information from the one or more user devices; or an indication that the second user device should maintain a sidelink-positioning reference signal transmission associated with a sidelink-positioning reference signal identification information indicated in the sidelink control information, only if there is a threshold number of user devices that indicate within their sidelink control information that sessionless positioning is performed based on the sidelink-positioning reference signal.

Example 33. The apparatus of any of Examples 26-32, wherein causing the apparatus to make the adjustment comprises causing the apparatus to: make a determination, by the second user device to modify transmission of one or more sidelink-positioning reference signals; transmit, by the second user device to a server user device or a location management function, a request to modify the sidelink-positioning reference signal transmission; receive, by the second user device from server user device or a location management function based on the request, a message indicating an updated sidelink-positioning reference signal transmission configuration for the second user device; and modify, by the second user device based on the received updated sidelink-positioning reference signal transmission configuration, the sidelink-positioning reference signal transmission.

Example 34. The apparatus of Example 33, wherein causing the apparatus to modify the sidelink-positioning reference signal transmission comprises causing the apparatus to perform at least one of the following: discontinue a transmission of a sidelink-positioning reference signal transmission based on less than a threshold number of user devices performing sessionless positioning based on the sidelink-positioning reference signal; begin transmission of a new sidelink-positioning reference signal; or adjust or change time-frequency resources to be used for the sidelink-positioning reference signal transmission.

Example 35. The apparatus of Example 34, wherein causing the apparatus to begin transmission of a new sidelink-positioning reference signal or adjust or change the time-frequency resources to be used for the sidelink-positioning reference signal transmission is based on preconfigured parameters that are preconfigured to the second user device by a server user device or location management function.

Example 36. A non-transitory computer-readable storage medium comprising instructions stored thereon that, when executed by at least one processor, are configured to cause a computing system to: receive, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determine, by the second user device, based on the user device identifier of the second user device, that the sidelink control information is addressed to the second user device; and continue to transmit or make an adjustment of a transmission of, by the second user device, the sidelink-positioning reference signal associated with the SL-PRS identification information.

Example 37. An apparatus comprising: means for receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; means for transmitting, by the first user device, sidelink control information including at least one of an indication that the first user device is performing sessionless positioning, a user device identifier of the first user device, the user device identifier of the second user device, or the SL-PRS identification information; and means for performing, by the first user device, at least one measurement on the sidelink-positioning reference signal transmitted by the second user device for sessionless positioning of the first user device.

Example 38. An apparatus comprising: means for receiving, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; means for determining, by the second user device, based on the user device identifier of the second user device, that the sidelink control information is addressed to the second user device; and means for continuing to transmit or making an adjustment of a transmission of, by the second user device, the sidelink-positioning reference signal associated with the SL-PRS identification information.

Example 39. A method comprising: receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmitting, by the first user device, information including at least one of an indication that the first user device is performing sessionless positioning, a user device identifier of the first user device, the user device identifier of the second user device, or the SL-PRS identification information; and performing, by the first user device, at least one measurement on the sidelink-positioning reference signal transmitted by the second user device for sessionless positioning of the first user device.

Example 40. An apparatus, comprising: at least one processor; and at least one memory storing instructions that, when executed by the at least one processor, cause the apparatus at least to: receive, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device; transmit, by the first user device, information including at least one of an indication that the first user device is performing sessionless positioning, a user device identifier of the first user device, the user device identifier of the second user device, or the SL-PRS identification information; and perform, by the first user device, at least one measurement on the sidelink-positioning reference signal transmitted by the second user device for sessionless positioning of the first user device.

Example 41. A method comprising: receiving, by a second user device from a first user device, information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determining, by the second user device, based on the user device identifier of the second user device, that the information is addressed to the second user device; and continuing to transmit or make an adjustment of a transmission of, by the second user device, the sidelink-positioning reference signal associated with the SL-PRS identification information.

Example 42. An apparatus, comprising: at least one processor; and at least one memory storing instructions that, when executed by the at least one processor, cause the apparatus at least to: receive, by a second user device from a first user device, information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device; determine, by the second user device, based on the user device identifier of the second user device, that the information is addressed to the second user device; and continue to transmit or make an adjustment of a transmission of, by the second user device, the sidelink-positioning reference signal associated with the SL-PRS identification information.

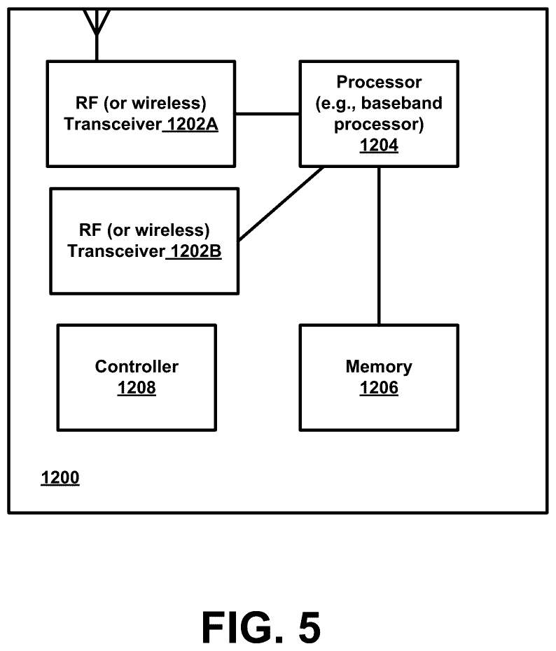

FIG. 5 is a block diagram of a wireless station (e.g., user node, network node, or other node) 1200 according to an example embodiment. The wireless station 1200 may include, for example, one or more (e.g., two as shown in FIG. 5) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 5, a controller (or processor) 1208 may execute software and instructions, and may provide overall control for the station 1200, and may provide control for other systems not shown in FIG. 5, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G may be similar to that of LTE-advanced. 5G is likely to use multiple input-multiple output (MIMO) antennas, many more base stations or nodes than LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node may be operationally coupled to a remote radio head. It is also possible that node operations will be distributed among a plurality of servers, nodes or hosts. It should also be understood that the distribution of labour between core network operations and base station operations may differ from that of the LTE or even be non-existent.

Embodiments of the various techniques described herein may be implemented in digital electronic circuitry, or in computer hardware, firmware, software, or in combinations of them. Embodiments may be implemented as a computer program product, i.c., a computer program tangibly embodied in an information carrier, e.g., in a machine readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-42. (canceled)

43. An apparatus, comprising:
at least one processor; and
at least one memory storing instructions that, when executed by the at least one processor, cause the apparatus at least to:
receive, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device;
transmit, by the first user device, sidelink control information including at least one of an indication that the first user device is performing sessionless positioning, a user device identifier of the first user device, the user device identifier of the second user device, or the SL-PRS identification information; and
perform, by the first user device, at least one measurement on the sidelink-positioning reference signal transmitted by the second user device for sessionless positioning of the first user device.

44. The apparatus of claim 43, wherein causing the apparatus to transmit the sidelink control information comprises causing the apparatus to:
transmit, by the first user device, the side link control information including the indication that the first user device is performing sessionless positioning, the user device identifier of the first user device as a source of the sidelink control information, the user device identifier of the second user device as a destination of the sidelink control information, and the SL-PRS identification information.

45. The apparatus of claim 43, wherein causing the apparatus to perform comprises causing the apparatus to:
detect, by the first user device, sidelink-positioning reference signal from the second user device; and
perform, by the first user device, at least one measurement on the detected sidelink-positioning reference signal for sessionless positioning of the first user device.

46. The apparatus of claim 43, further causing the apparatus to:
transmit, by the first user device to a server user device or a location management function, at least one of a request to perform sessionless positioning, or a user device identifier of one or more second user devices that the first user device has detected or received signal from.

47. The apparatus of claim 43, wherein the SL-PRS identification information associated with the sidelink-positioning reference signal transmitted by the second user device comprises at least one of the following:
a sidelink-positioning reference signal sequence identifier associated with the sidelink-positioning reference signal transmitted by the second user device; or
a sidelink-positioning reference signal resource identifier indicating or associated with resources for the sidelink-positioning reference signal transmitted by the second user device.

48. The apparatus of claim 43, further causing the apparatus to:
receive, by the first user device, information indicating a period or periodicity that the first user device should transmit, the sidelink control information.

49. The apparatus of claim 43, further causing the apparatus to:
receive, by the first user device from a server user device or a location management function, a message indicating information that the first user device should include within its sidelink control information.

50. An apparatus, comprising:
at least one processor; and
at least one memory storing instructions that, when executed by the at least one processor, cause the apparatus at least to:
receive, by a second user device from a first user device, sidelink control information including at least one of an indication that the first user device is performing sessionless positioning, a user device identifier of the first user device, a user device identifier of the second user device, or sidelink-positioning reference signal (SL-PRS) identification information associated with sidelink-positioning reference signal transmitted by the second user device;
determine, by the second user device, based on the user device identifier of the second user device, that the sidelink control information is addressed to the second user device; and
continue to transmit or make an adjustment of a transmission of, by the second user device, the sidelink-positioning reference signal associated with the SL-PRS identification information.

51. The apparatus of claim 50, further causing the apparatus to:
receive, by the second user device, a signal power or signal quality threshold, above which a received sidelink control information is considered to be valid; and
determine that the received sidelink control information is valid based on a signal power or a signal quality of the received sidelink control information.

52. The apparatus of claim 50, wherein causing the apparatus to continue to transmit or make an adjustment comprises causing the apparatus to:
continue to transmit or make the adjustment of a transmission of, by the second user device, the sidelink-positioning reference signal associated with the SL-PRS identification information based on the received sidelink control information.

53. The method of claim 50, wherein causing the apparatus to continue to transmit or make an adjustment comprises:
continue to transmit or make the adjustment of a transmission of, by the second user device, the sidelink-positioning reference signal associated with the SL-PRS identification information based on the determination that the received sidelink control information is valid and addressed to the second user device.

54. The apparatus of claim 50, wherein causing the apparatus to receive sidelink control information comprises causing the apparatus to:
receive, by the second user device from the first user device, sidelink control information including the indication that the first user device is performing sessionless positioning, the user device identifier of the first user as a source of the sidelink control information, the user device identifier of the second user device as a destination of the sidelink control information, and the sidelink-positioning reference signal (SL-PRS) identification information.

55. The apparatus of claim 50, wherein the SL-PRS identification information associated with the sidelink-positioning reference signal transmitted by the second user device comprises at least one of the following:
a sidelink-positioning reference signal sequence identifier associated with the sidelink-positioning reference signal transmitted by the second user device; or
a sidelink-positioning reference signal resource identifier indicating or associated with resources for the sidelink-positioning reference signal transmitted by the second user device.

56. The apparatus of claim 50, further causing the apparatus to:
receive, by the second user device, at least one of the following:
one or more user device identifiers of user devices for which the second user device should monitor the sidelink control information;
an indication of a time window, within which the second user device should monitor the sidelink control information from the one or more user devices; or
an indication that the second user device should maintain a sidelink-positioning reference signal transmission associated with a sidelink-positioning reference signal identification information indicated in the sidelink control information, only if there is a threshold number of user devices that indicate within their sidelink control information that sessionless positioning is performed based on the sidelink-positioning reference signal.

57. The apparatus of claim 50, wherein causing the apparatus to make the adjustment comprises causing the apparatus to:
make a determination, by the second user device to modify transmission of one or more sidelink-positioning reference signals;
transmit, by the second user device to a server user device or a location management function, a request to modify the sidelink-positioning reference signal transmission;
receive, by the second user device from server user device or a location management function based on the request, a message indicating an updated sidelink-positioning reference signal transmission configuration for the second user device; and
modify, by the second user device based on the received updated sidelink-positioning reference signal transmission configuration, the sidelink-positioning reference signal transmission.

58. The apparatus of claim 57, wherein causing the apparatus to modify the sidelink-positioning reference signal transmission comprises causing the apparatus to perform at least one of the following:
discontinue a transmission of a sidelink-positioning reference signal transmission based on less than a threshold number of user devices performing sessionless positioning based on the sidelink-positioning reference signal;
begin transmission of a new sidelink-positioning reference signal; or
adjust or change time-frequency resources to be used for the sidelink-positioning reference signal transmission.

59. The apparatus of claim 58, wherein causing the apparatus to begin transmission of a new sidelink-positioning reference signal or adjust or change the time-frequency resources to be used for the sidelink-positioning reference signal transmission is based on preconfigured parameters that are preconfigured to the second user device by a server user device or location management function.

60. A method, comprising:
receiving, by a first user device in a wireless network that is performing sessionless positioning based on sidelink-positioning reference signal (SL-PRS), a user device identifier of a second user device in a vicinity of the first user device that is transmitting sidelink-positioning reference signal and SL-PRS identification information associated with the sidelink-positioning reference signal transmitted by the second user device;
transmitting, by the first user device, sidelink control information including at least one of an indication that the first user device is performing sessionless positioning, a user device identifier of the first user device, the user device identifier of the second user device, or the SL-PRS identification information; and
performing, by the first user device, at least one measurement on the sidelink-positioning reference signal transmitted by the second user device for sessionless positioning of the first user device.

61. The method of claim 60, wherein the transmitting sidelink control information comprises:
transmitting, by the first user device, the sidelink control information including the indication that the first user device is performing sessionless positioning, the user device identifier of the first user device as a source of the sidelink control information, the user device identifier of the second user device as a destination of the sidelink control information, and the SL-PRS identification information.

62. The method of claim 60, wherein the performing comprises:
detecting, by the first user device, sidelink-positioning reference signal from the second user device; and
performing, by the first user device, at least one measurement on the detected sidelink-positioning reference signal for sessionless positioning of the first user device.
